(19) United States
(12) Patent Application Publication
(10) Pub. No.: US 2026/0365567 A1
(43) Pub. Date: Nov. 19, 2026

(54) GLASS PROCESSING APPARATUS, GLASS PROCESSING METHOD, AND METHOD OF MANUFACTURING ELECTRONIC APPARATUS

(71) Applicant: Samsung Display Co., Ltd., Yongin-si (KR)

(72) Inventors: Katsuyuki HIRATO, Yongin-si (KR); Keunsoo LEE, Yongin-si (KR); Jaihyuk CHOI, Yongin-si (KR); Dohun LEE, Yongin-si (KR); Minwoo LEE, Yongin-si (KR); Kyungsik HWANG, Yongin-si (KR)

(73) Assignee: Samsung Display Co., Ltd., Yongin-si (KR)

(21) Appl. No.: 19/572,175

(22) Filed: Mar. 19, 2026

(30) Foreign Application Priority Data
May 16, 2025 (KR) 10-2025-0064041
Jul. 9, 2025 (KR) 10-2025-0092585

(51) Int. Cl. C03C 17/32; C03C 15/00; C03C 17/34

(52) U.S. Cl. CPC C03C 17/32; C03C 15/00; C03C 17/3405

(57) ABSTRACT

Provided are a glass processing apparatus capable of easily etching glass into a preset shape, a glass processing method performed by the glass processing apparatus, and a method of manufacturing an electronic apparatus. The glass processing method includes providing a glass substrate comprising a first glass portion and a second glass portion; forming a first organic layer on the first glass portion; forming a second organic layer on the second glass portion and a portion of the first organic layer; removing the first organic layer; etching the glass substrate; and removing the second organic layer.

### CROSS-REFERENCE TO RELATED APPLICATIONS

This application claims priority under 35 U.S.C. §119 to Korean Provisional Patent Application No. 10-2025-0064041, filed on May 16, 2025, and Korean Patent Application No. 10-2025-0092585, filed on Jul. 9, 2025, in the Korean Intellectual Property Office, the disclosures of which are incorporated by reference herein in their entireties.

### BACKGROUND

### 1. Field

The present disclosure relates to a glass processing apparatus, a glass processing method, and a method of manufacturing an electronic apparatus, and more particularly, to a glass processing apparatus capable of easily etching glass into a preset shape, a glass processing method performed by the glass processing apparatus, and a method of manufacturing an electronic apparatus, the method including the glass processing method.

### 2. Description of Related Art

Display apparatuses may be utilized as various electronic apparatuses. For example, a display apparatus may be a mobile electronic apparatus, such as a smartphone. Such an electronic apparatus may be a foldable electronic apparatus in which part of a display surface is folded to reduce the overall size of the electronic apparatus and also increase the area of the display surface of the electronic apparatus.

These display apparatuses can be formed by coupling various members to each other. In detail, a display apparatus can be formed by attaching a cover window for protecting a display panel to the display panel including a display element. The cover window may include a groove for facilitating folding of a display apparatus, and the groove may be formed by etching glass that is a material of the cover window.

However, in a manufacturing method of this electronic apparatus according to related art, it is difficult to etch glass, which is a material of a cover window, into a preset shape when etching the glass.

### SUMMARY

One or more embodiments include a glass processing apparatus capable of easily etching glass into a preset shape, a glass processing method, and a method of manufacturing an electronic apparatus. However, aspects of embodiments according to the disclosure are not limited thereto, and the above characteristics do not limit the scope of embodiments according to the disclosure.

Additional aspects will be set forth in portion in the description which follows and, in part, will be apparent from the description, or may be learned by practice of the presented embodiments of the disclosure.

According to an aspect of an embodiment, a glass processing method includes: providing a glass substrate having a first glass portion and a second glass portion; forming a first organic layer on the first glass portion; forming a second organic layer on the second glass portion and a portion of the first organic layer; removing the first organic layer; etching the glass substrate; and removing the second organic layer.

The etching of the glass substrate may include etching the first glass portion and a portion of the second glass portion adjacent to the first glass portion.

The forming of the first organic layer may include discharging a first solution onto the first glass portion and irradiating the first solution with ultraviolet light. The forming of the second organic layer may include discharging a second solution onto the second glass portion and the portion of the first glass portion and irradiating the second solution with ultraviolet light. The removing of the first organic layer may include removing the first organic layer by using a first solvent containing water and not removing the second organic layer. The removing of the second organic layer may include removing the second organic layer by using a second solvent, which is an organic solvent. At least one of the removing of the first organic layer and the removing of the second organic layer may include at least one of heating and ultrasonic vibration.

The first solution may include at least one of polyvinylalcohol, polyvinylpyrrolidone, polyacrylic acid, polyethylene glycol, polyglycidol, hydroxyethyl cellulose, methyl cellulose, carboxymethyl cellulose, and dextrin. The second solution may include at least one of polystyrene, polymethyl methacrylate, novolac resin, polyimide, epoxy resin, acrylic resin, polyvinylphenol, polyhydroxystyrene, cycloolefin polymer, and polycarbonate.

The first solution may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

The second solution may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

The forming of the second organic layer may include radiating a first amount of ultraviolet light radiated to the second solution on the portion of the first glass portion is different from a second amount of ultraviolet light radiated to the second solution on the second glass portion.

The first amount of ultraviolet light may be greater than the second amount of ultraviolet light.

The forming of the second organic layer may include forming a second-1 organic portion of the second organic layer on the portion of the first glass portion and forming a second-2 organic portion of the second organic layer on the second glass portion to directly contact the second glass portion.

The second-1 organic portion may be thicker than the second-2 organic portion.

According to another aspect of an embodiment, a glass processing apparatus includes: a discharge device configured to discharge a first solution and a second solution onto a glass substrate; an irradiation device configured to radiate ultraviolet light to the first solution and the second solution discharged onto the glass substrate; a removal device configured to remove a first organic layer formed from the first solution and a second organic layer formed from the second solution and etch the glass substrate; and a controller configured to: control the discharge device and the irradiation device to form the first organic layer on a first glass portion of the glass substrate, control the discharge device and the irradiation device to form the second organic layer on a second glass portion of the glass substrate in contact with the first glass portion, and on a portion of the first organic layer, control the removal device to remove the first organic layer, control the removal device to etch the glass substrate, and control the removal device to remove the second organic layer. The controller may be further configured to control the removal device to etch the first glass portion and a portion of the second glass portion adjacent to the first glass portion.

The controller may be further configured to: control the discharge device to discharge the first solution onto the first glass portion and control the irradiation device to radiate ultraviolet light to cure the first solution and form the first organic layer, control the discharge device to discharge the second solution onto the second glass portion and the portion of the first glass portion, and control the irradiation device to radiate ultraviolet light to cure the second solution and form the second organic layer, control the removal device to remove the first organic layer by using a first solvent containing water and to not remove the second organic layer, and control the removal device to remove the second organic layer by using a second solvent, which is an organic solvent. The removal device may be configured to apply at least one of heating and ultrasonic vibration when removing the first organic layer or the second organic layer.

The first solution may include at least one of polyvinylalcohol, polyvinylpyrrolidone, polyacrylic acid, polyethylene glycol, polyglycidol, hydroxyethyl cellulose, methyl cellulose, carboxymethyl cellulose, and dextrin. The second solution may include at least one of polystyrene, polymethyl methacrylate, novolac resin, polyimide, epoxy resin, acrylic resin, polyvinylphenol, polyhydroxystyrene, cycloolefin polymer, and polycarbonate.

The first solution may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

The second solution may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

The controller may be further configured to control the irradiation device so that a first amount of ultraviolet light radiated to the second solution discharged onto the portion of the first glass portion is greater than a second amount of ultraviolet light radiated to the second solution discharged onto the second glass portion.

The controller may be further configured to control the discharge device and the irradiation device so that a second-1 organic portion of the second organic layer formed on the first glass portion overlaps a portion of the first organic layer and a second-2 organic portion of the second organic layer formed on the second glass portion comes into direct contact with the second glass portion.

The controller may be further configured to control the discharge device and the irradiation device so that the second-1 organic portion is thicker than the second-2 organic portion.

According to another aspect of an embodiment, a method of manufacturing an electronic apparatus, includes: forming a cover window; and attaching the cover window to a display panel. The forming of the cover window includes: providing a glass substrate having a first glass portion and a second glass portion; forming a first organic layer on the first glass portion; forming a second organic layer on the second glass portion and a portion of the first organic layer; removing the first organic layer; etching the glass substrate; and removing the second organic layer.

These and/or other aspects will become apparent and more readily appreciated from the following description of embodiments, the claims, and the accompanying drawings.

### BRIEF DESCRIPTION OF DRAWINGS

The above and other aspects, features, and advantages will be more apparent from the following description of embodiments, taken in conjunction with the accompanying drawings, in which:

FIG. 1 is a block diagram of an example of a glass processing apparatus according to an embodiment;

FIG. 2 is a conceptual diagram of a glass processing apparatus according to an embodiment;

FIG. 3 is a flowchart of a glass processing method according to an embodiment;

FIGS. 4 - 8 are views for explaining the glass processing method of FIG. 3;

FIGS. 9 and 10 are views for explaining a glass processing method according to a comparative example;

FIG. 11 is a view for explaining a glass processing method according to an embodiment;

FIGS. 12 and 13 are views for explaining a glass processing method according to an embodiment;

FIG. 14A is a schematic block diagram of an electronic apparatus manufactured according to an embodiment;

FIG. 14B is a schematic diagram of electronic apparatuses manufactured according to embodiments;

FIG. 15 is a schematic perspective view of a display apparatus included in an electronic apparatus manufactured according to an embodiment;

FIG. 16 is a schematic side view of a display apparatus included in an electronic apparatus manufactured according to an embodiment;

FIG. 17 is a schematic cross-sectional view of the display apparatus of FIG. 15 taken along line I-I’;

FIG. 18 is a schematic plan view of a display panel included in the display apparatus of FIG. 17;

FIG. 19 is an equivalent circuit diagram of a pixel circuit included in the display panel of FIG. 18;

FIG. 20 is a schematic cross-sectional view of the display panel of FIG. 18 taken along line II-II’; and

FIG. 21 is a flowchart of a portion of a method of manufacturing an electronic apparatus, according to an embodiment.

### DETAILED DESCRIPTION

Reference will now be made in detail to embodiments, examples of which are illustrated in the accompanying drawings, wherein like reference numerals refer to like elements throughout. In this regard, embodiments may have different forms and should not be construed as being limited to the descriptions set forth herein. Accordingly, embodiments are merely described below, by referring to the figures, to explain aspects of the present description. As used herein, the term “and/or” includes any and all combinations of one or more of the associated listed items. Throughout the disclosure, the expression “at least one of a, b or c” indicates only a, only b, only c, both a and b, both a and c, both b and c, all of a, b, and c, or variations thereof.

As the disclosure allows for various changes and numerous embodiments, particular embodiments will be illustrated in the drawings and described in detail in the written description. Hereinafter, effects and features of the disclosure and a method for accomplishing them will be described more fully with reference to the accompanying drawings, in which embodiments of the disclosure are shown. The disclosure may, however, be embodied in many different forms and should not be construed as limited to embodiments set forth herein.

It will be understood that although the terms “first,” “second,” etc., may be used herein to describe various components, these components should not be limited by these terms. These components are only used to distinguish one component from another.

As used herein, the singular forms “a,” “an,” and “the” are intended to include the plural forms as well, unless the context clearly indicates otherwise.

It will be further understood that the terms “comprises” and/or “comprising” used herein specify the presence of stated features or components, but do not preclude the presence or addition of one or more other features or components.

In the present specification, “A and/or B” represents A or B, or A and B. The expression “at least one of A and B” indicates only A, only B, both A and B, or variations thereof.

It will be understood that, unless otherwise specified, when an element such as a layer, film, region or substrate is referred to as being “on” another element, it can be “directly” on the other element or intervening elements may also be present.

When a layer, region, or component is referred to as being “connected” or “coupled” to another layer, region, or component, it can be directly connected or coupled to the other layer, region, or/and component or intervening layers, regions, or components may be present. For example, when a layer, region, or component is referred to as being “electrically connected” or “electrically coupled” to another layer, region, or component, it can be directly electrically connected or coupled to the other layer, region, and/or component or intervening layers, regions, or components may be present.

In the following examples, the x-axis, the y-axis and the z-axis are not limited to three axes of the rectangular coordinate system, and may be interpreted in a broader sense. For example, the x-axis, the y-axis, and the z-axis may be perpendicular to one another, or may represent different directions that are not perpendicular to one another.

When a certain embodiment may be implemented differently, a specific process order may be performed differently from the described order. For example, two consecutively described processes may be performed substantially at the same time or performed in an order opposite to the described order.

The expression “in a plan view” used herein refers to when an object portion is viewed from the top. In this regard, the expression “in a plan view” used herein may refer to “when viewed in a direction perpendicular to a substrate 100”.

One or more embodiments will be described below in more detail with reference to the accompanying drawings. Those components that are the same as or are in correspondence with each other are rendered the same reference numeral regardless of the figure number, and redundant explanations are omitted. In the drawings, the thicknesses of layers and regions are exaggerated or reduced for convenience of explanation. For example, because sizes and thicknesses of components in the drawings are arbitrarily illustrated for convenience of explanation, embodiments are not limited thereto.

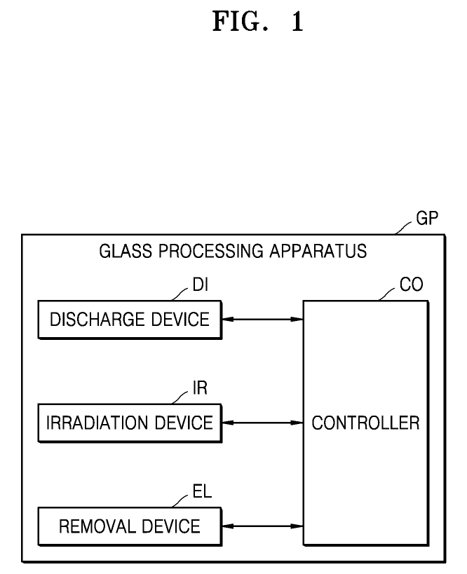

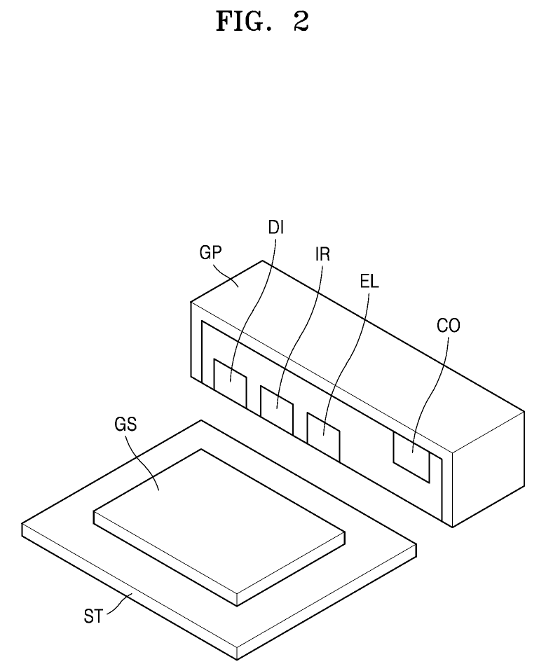

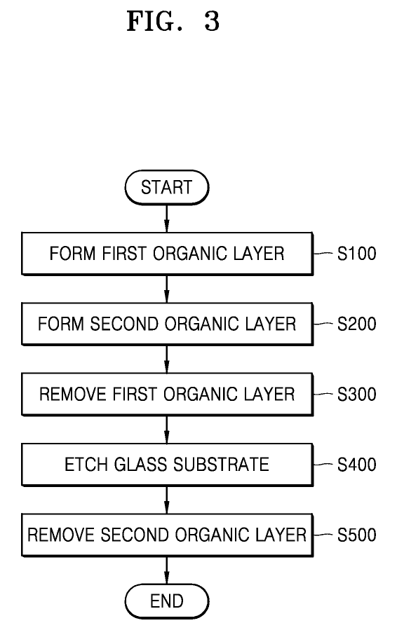

FIG. 1 is a block diagram of a glass processing apparatus GP according to an embodiment. FIG. 2 is a conceptual diagram of the glass processing apparatus GP according to an embodiment. A glass processing method according to an embodiment, which will be described later with reference to FIGS. 3 - 8, may be executed through the glass processing apparatus GP. The glass processing apparatus GP may be any apparatus that processes glass, without limitations.

Referring to FIG. 1, the glass processing apparatus GP may include a discharge device DI, an irradiation device IR, a removal device EL, and a controller CO. As will be appreciated by those skilled in the art the glass processing apparatus GP may further include components other than the components illustrated in FIG. 1. The glass processing apparatus GP may include or be connected to several apparatuses for controlling or operating the components illustrated in FIG. 1.

Moreover, as long as an apparatus including only some of the components illustrated in FIG. 1 is capable of achieving the objective of the disclosure, the apparatus may also correspond to the glass processing apparatus GP. For example, the glass processing apparatus GP may include only the removal device EL and the controller CO, and the discharge device DI and the irradiation device IR may be arranged outside the glass processing apparatus GP. That is, the glass processing apparatus GP illustrated in FIG. 1 is only an example, and may be modified in various ways as recognized by those skilled in the art.

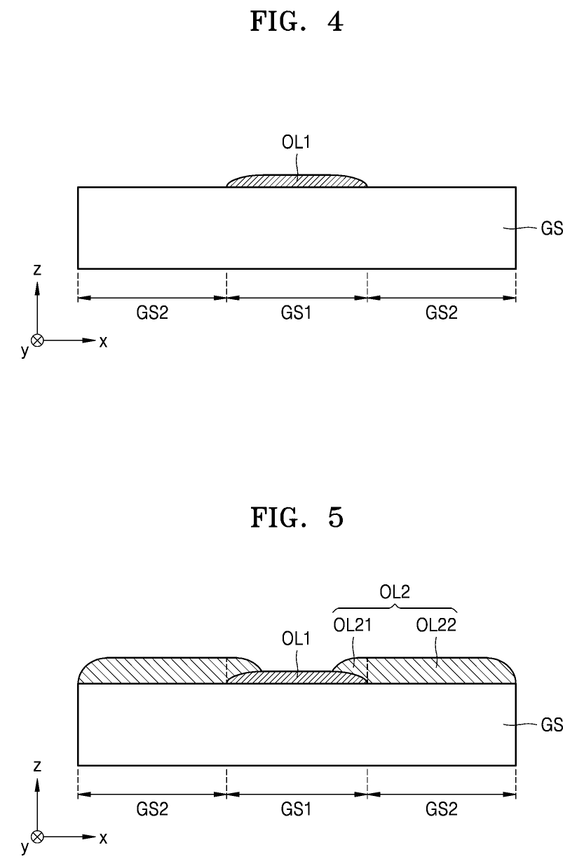

The discharge device DI may discharge an organic material capable of forming an organic layer onto a glass substrate GS. In detail, the discharge device DI may discharge a first solution and a second solution onto the glass substrate GS. As will be described below, a first organic layer OL1 (see FIG. 4) may be formed from the first solution, and a second organic layer OL2 (see FIG. 5) may be formed from the second solution. That is, the first solution may include an organic material capable of forming the first organic layer OL1, and the second solution may include an organic material capable of forming the second organic layer OL2.

For example, the discharge device DI may include at least one of an inkjet printer, a spin coater, a dispenser, a slot die coater, and a spray coater. However, embodiments are not limited thereto, and any device capable of discharging an organic material capable of forming an organic layer onto the glass substrate GS may be as the discharge device DI.

The irradiation device IR may radiate ultraviolet (UV) light to the organic material discharged onto (i.e., on) the glass substrate GS. In detail, the irradiation device IR may radiate UV light to the first solution and the second solution discharged onto (i.e., on) the glass substrate GS.

For example, the irradiation device IR may include at least one of a UV light-emitting diode (LED), a UV lamp, a mercury lamp, a metal halide lamp, a xenon lamp, and an excimer laser. However, embodiments are not limited thereto, and any device capable of radiating UV light to organic material discharged onto the glass substrate GS may be implemented as the irradiation device IR.

The removal device EL may remove an organic layer formed on the glass substrate GS, and may etch the glass substrate GS. In detail, the removal device EL may remove the first organic layer OL1 and the second organic layer OL2.

For example, the removal device EL may spray a solvent capable of dissolving an organic layer onto the organic layer, and may spray an etchant capable of etching the glass substrate GS onto the glass substrate GS. For example, the removal device EL may include at least one of a spray nozzle and a dispenser. However, embodiments are not limited thereto, and any device capable of spraying a solvent capable of dissolving an organic layer onto the organic layer and spraying an etchant capable of etching the glass substrate GS onto the glass substrate GS may be implemented as the removal device EL.

According to an embodiment, to promote removal of the organic layer, the removal device EL may heat the organic layer or apply ultrasonic vibration to the organic layer. In detail, the removal device EL may heat the first organic layer OL1 and the second organic layer OL2, or may apply ultrasonic vibration to the first organic layer OL1 and the second organic layer OL2. In some embodiments, the removal device EL may heat the first organic layer OL1 and the second organic layer OL2, and apply ultrasonic vibration to the first organic layer OL1 and the second organic layer OL2. For example, the heat and ultrasonic vibration may be simultaneously applied. For example, the removal device EL may include at least one of a heater and a sonicator. However, embodiments are not limited thereto, and any device capable of heating an organic layer or applying ultrasonic vibration to the organic layer may be included in the removal device EL.

The controller CO controls overall functions for executing the glass processing apparatus GP. In detail, the controller CO may control the discharge device DI, the irradiation device IR, and the removal device EL. For example, the controller CO may be connected to the discharge device DI, the irradiation device IR, and the removal device EL to control operations of the discharge device DI, the irradiation device IR, and the removal device EL. The controller CO may include a microcomputer and various interfaces, and may control the operations of the discharge device DI, the irradiation device IR, and the removal device EL according to a program and recipe information stored in external memory or internal memory.

In detail, as illustrated in FIG. 2, the glass substrate GS may be seated on a stage ST. The controller CO may control the discharge device DI to discharge an organic material used to form an organic layer on the glass substrate GS, and the controller CO may control the irradiation device IR to radiate UV light to the organic material discharged onto the glass substrate GS. The controller CO may also control the removal device EL to spray a solvent capable of dissolving an organic layer onto the organic layer, and the controller CO may also control the removal device EL to spray an etchant capable of etching the glass substrate GS onto the glass substrate GS.

The stage ST may support the glass substrate GS by seating the glass substrate GS thereon, and the stage ST may include an electrostatic chuck for fixing the glass substrate GS on the stage ST. The electrostatic chuck may fix the glass substrate GS onto the stage ST by using an electrostatic adsorption force. Although the stage ST is illustrated as being disposed outside the glass processing apparatus GP in FIGS. 1 and 2, embodiments are not limited thereto. For example, the glass processing apparatus GP may further include the stage ST.

According to an embodiment, the stage ST may be coated with a UV absorbing material. For example, the UV absorbing material may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound. The stage ST coated with the UV absorbing material may prevent UV light radiated onto an organic material on the glass substrate GS from being reflected by the stage ST and being re-incident upon a lower portion of the organic material. Therefore, when an organic layer formed from an organic material, the organic layer may be easily removed.

FIG. 3 is a flowchart of a glass processing method according to an embodiment. FIGS. 4 - 8 are views for explaining the glass processing method of FIG. 3.

Referring to FIG. 3, the glass processing method according to an embodiment may include a first organic layer forming operation S100, a second organic layer forming operation S200, a first organic layer removing operation S300, a glass substrate etching operation S400, and a second organic layer removing operation S500.

In the first organic layer forming operation S100, referring to FIG. 4, the first organic layer OL1 may be formed on the glass substrate GS.

The glass substrate GS may include glass and may have a flat upper surface. That is, the glass substrate GS may have a plate shape. The glass substrate GS may include SiO₂, Al₂O₃, B₂O₃, P₂O₅, Li₂O, Na₂O, K₂O, MgO, CaO, SrO, BaO, ZnO, TiO₂, or ZrO₂. In addition to the aforementioned components, the glass substrate GS may further include components, such as Y₂O₃, La₂O₃, Nb₂O₅, Ta₂O₅, or Gd₂O₃, as needed. However, embodiments are not limited thereto, and the glass substrate GS may include glass used in glass products.

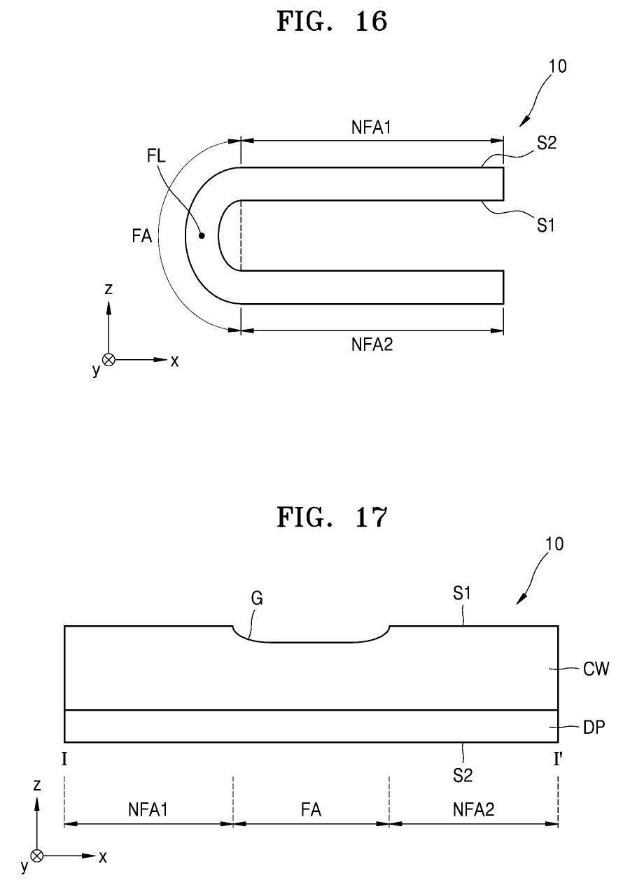

A portion of the glass substrate GS may be etched to form a cover window CW (see FIG. 17) which will be described later. That is, the glass substrate GS may be a material of the cover window CW. To this end, a portion of the glass substrate GS may be selectively etched. The second organic layer OL2 (see FIG. 5) may serve as a mask to selectively etch a portion of the glass substrate GS, and the first organic layer OL1 may allow the second organic layer OL2 to be formed in a preset shape.

The glass substrate GS may include a first glass portion GS1 and a second glass portion GS2. The first glass portion GS1 may be a portion where the first organic layer OL1 is to be formed. The second glass portion GS2, which is a portion in contact with (i.e., adjacent) the first glass portion GS1, may be a portion where the second organic layer OL2 is formed. For example, a portion of the second glass portion GS2 may be disposed on one side of the first glass portion GS1, and another portion of the second glass portion GS2 may be disposed on the other side of the first glass portion GS1. The first organic layer OL1 may be formed on the first glass portion GS1 of the glass substrate GS. That is, the first glass portion GS1 may be a portion that is to directly contact the first organic layer OL1, and the second glass portion GS2 may be a portion that is to directly contact the second organic layer OL2.

In detail, the first solution may be discharged onto the first glass portion GS1 by using inkjet printing. The first solution discharged onto the first glass portion GS1 may be irradiated with UV light to cure the first solution. Accordingly, the first organic layer OL1 may be formed on the first glass portion GS1. That is, the first solution is a first organic layer composition, and the first organic layer OL1 is a cured product of the first solution.

In this regard, the controller CO may control the discharge device DI to discharge the first solution onto the first glass portion GS1 of the glass substrate GS. Thereafter, the controller CO may control the irradiation device IR to radiate UV light to the first solution discharged onto the first glass portion GS1. Accordingly, the first organic layer OL1 may be formed on the first glass portion GS1. In this regard, the controller CO may control the discharge device DI and the irradiation device IR to form the first organic layer OL1 on the first glass portion GS1 of the glass substrate GS.

According to an embodiment, the first organic layer OL1 may include a polymer that may be dissolved in water, i.e., a water-soluble polymer. For example, the first solution may include a first monomer having a large number of hydrophilic groups such as an alcohol group, a sulfonic acid group, a carboxylic acid group, and a phosphoric acid group, and/or a first polymer formed by polymerizing the first monomer. For example, the first solution may include at least one of polyvinylalcohol, polyvinylpyrrolidone, polyacrylic acid, polyethylene glycol, polyglycidol, hydroxyethyl cellulose, methyl cellulose, carboxymethyl cellulose, and dextrin. Accordingly, the first organic layer OL1, which is a cured product of the first solution, may be dissolved in water. However, embodiments are not limited thereto.

According to an embodiment, the first solution may further include a UV absorbing material. For example, the UV absorbing material may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound. When the first solution discharged onto the glass substrate GS is irradiated with UV light, the UV absorbing material included in the first solution may absorb the UV light from an upper portion of the first solution, and thus may reduce the amount of UV light reaching a lower portion of the first solution, i.e., the vicinity of an interface with the glass substrate GS. Accordingly, the lower portion of the first solution may have a relatively low degree of hardening, compared to the upper portion thereof. Therefore, when the first organic layer OL1 formed from the first solution is removed, the first organic layer OL1 may be easily removed.

According to an embodiment, after the first solution is discharged onto the glass substrate GS, a predetermined waiting time may be allowed before radiation of UV light so that the first solution may wet or spread on a surface of the glass substrate GS. The predetermined waiting time may be, for example, 5 to 60 seconds.

According to an embodiment, the discharge amount of the first solution may be gradually reduced in a direction from a center of the first glass portion GS1 to an edge of the first glass portion GS1 to form a gradation-shaped thickness profile. Accordingly, a thickness of the first organic layer OL1 at the edge of the first glass portion GS1 may be formed to be lower than a thickness of the first organic layer OL1 at the center of the first glass portion GS1.

According to an embodiment, the first solution may be repeatedly discharged onto the first glass portion GS1 a plurality of times, and a discharge pattern, particularly at the edge of the first glass portion GS1, may be changed differently during each discharge. Accordingly, duplicate discharge at the same location may be prevented, and a uniform gradation effect may be achieved.

According to another embodiment, the first solution may be repeatedly discharged onto the first glass portion GS1, and the area of the first glass portion GS1 onto which the first solution is discharged may be gradually reduced. For example, the area of the first glass portion GS1 onto which the first solution is discharged for the second time may be less than the area of the first glass portion GS1 onto which the first solution is discharged for the first time, and the area of the first glass portion GS1 onto which the first solution is discharged for the third time may be less than the area of the first glass portion GS1 onto which the first solution is discharged for the second time.

According to an embodiment, the glass substrate GS may be surface-treated before the first solution is discharged onto the first glass portion GS1. The surface treatment may be at least one of plasma treatment and corona discharge treatment.

According to an embodiment, an unpolymerization rate of the first organic layer OL1 may be 0.1 to 0.8. The unpolymerization rate of one layer refers to a value obtained by dividing the intensity of an absorbance peak derived from an unsaturated bond of a not-yet cured material by the intensity of an absorbance peak derived from an unsaturated bond of a cured material. Absorbance may be measured using an infrared spectrophotometer (e.g., FT/IR-4X by Jasco). For example, when an acrylic monomer is cured to form an organic layer, the unpolymerization rate may be calculated using the intensity of an absorbance peak of a wavelength of about 810 cm¹ corresponding to an unsaturated ethylene bond (e.g., a carbon-carbon double bond).

That is, when the intensity of an absorbance peak derived from an unsaturated bond of a material included in the first solution is a and the intensity of an absorbance peak derived from an unsaturated bond of a material included in the first organic layer OL1 is b, the unpolymerization rate of the first organic layer OL1 may be b/a. When the unpolymerization rate of the first organic layer OL1 is less than 0.1 and the second solution is discharged onto the first organic layer OL1, the second solution may not be discharged to a preset location due to a repulsive force between the first organic layer OL1 and the second solution. When the unpolymerization rate of the first organic layer OL1 exceeds 0.8, the first organic layer OL1 does not have sufficient structural rigidity, and thus may not stably maintain the shape of the first organic layer OL1.

In the operation S200 of forming the second organic layer OL2, referring to FIG. 5, the second organic layer OL2 may be formed on the second glass portion GS2 of the glass substrate GS. In detail, the second organic layer OL2 may be formed on the second glass portion GS2 and a portion of the first glass portion GS1 that contacts the second glass portion GS2. Because the first organic layer OL1 is formed on the first glass portion GS1, the second organic layer OL2 may cover at least a portion of the first organic layer OL1. That is, the second organic layer OL2 may be formed on the second glass portion GS2 and a portion of the first organic layer OL1.

The second organic layer OL2 may include a second-1 organic portion OL21 and a second-2 organic portion OL22. The second-1 organic portion OL21 may be formed on the first glass portion GS1. In detail, the second-1 organic portion OL21 may be formed on a portion of the first glass portion GS1 that is adjacent to the second glass portion GS2. Accordingly, the second-1 organic portion OL21 may overlap the first glass portion GS1. The second-1 organic portion OL21 may overlap the first organic layer OL1. In detail, the second-1 organic portion OL21 may overlap a portion of the first glass portion GS1 and a portion of the first organic layer OL1.

The second-2 organic portion OL22 may be formed on the second glass portion GS2. Accordingly, the second-2 organic portion OL22 may overlap the second glass portion GS2. In this regard, the second-2 organic portion OL22 may directly contact the second glass portion GS2. The first organic layer OL1 may be interposed between the second-1 organic portion OL21 and the first glass portion GS1, and the second-1 organic portion OL21 may be in direct contact with the first organic layer OL1. In this regard, the controller CO may control the discharge device DI and the irradiation device IR so that the second-1 organic portion OL21 of the second organic layer OL2 overlaps a portion of the first organic layer OL1 and the second-2 organic portion OL22 of the second organic layer OL2 is in direct contact with the second glass portion GS2.

In detail, the second solution may be discharged onto the second glass portion GS2 and a portion of the first glass portion GS1 adjacent to the second glass portion GS2, via inkjet printing. Then, UV light may be radiated to the second solution discharged onto the second glass portion GS2 and the portion of the first glass portion GS1 adjacent to the second glass portion GS2 to cure the second solution. Accordingly, the second organic layer OL2 may be formed on the second glass portion GS2 and the portion of the first glass portion GS1 adjacent to the second glass portion GS2. That is, the second solution is a second organic layer composition, and the second organic layer OL2 is a cured product of the second solution.

In this regard, the controller CO may control the discharge device DI to discharge the second solution onto the second glass portion GS2 of the glass substrate GS and a portion of the first organic layer OL1. Thereafter, the controller CO may control the irradiation device IR to radiate UV light to the second solution discharged onto the second glass portion GS2 and a portion of the first organic layer OL1. Accordingly, the second organic layer OL2 may be formed on the second glass portion GS2 and a portion of the first organic layer OL1. In this regard, the controller CO may control the discharge device DI and the irradiation device IR to form the second organic layer OL2 on the second glass portion GS2 of the glass substrate GS and a portion of the first organic layer OL1.

According to an embodiment, the amount of UV light radiated to the second solution discharged onto a portion of the first glass portion GS1 may be different from the amount of UV light radiated to the second solution discharged onto the second glass portion GS2. In detail, the amount of UV light radiated to the second solution discharged onto a portion of the first glass portion GS1 (i.e., the second solution on the first glass portion GS1) may be greater than the amount of UV light radiated to the second solution discharged onto the second glass portion GS2 (i.e., the second solution on the second glass portion GS2). In this regard, the controller CO may control the irradiation device IR so that the amount of UV light radiated to the second solution discharged onto a portion of the first glass portion GS1 may be greater than the amount of UV light radiated to the second solution discharged onto the second glass portion GS2. That is, the amount of UV light radiated to the second solution discharged onto the second glass portion GS2 may be less than the amount of UV light radiated to the second solution discharged onto a portion of the first glass portion GS1.

For example, UV light of the same intensity may be radiated to the second solution discharged onto the first glass portion GS1 for a long period of time, and may be radiated to the second solution discharged onto a portion of the second glass portion GS2 for a short period of time. Alternatively, UV light of the same intensity may be radiated to the second solution discharged onto the second glass portion GS2 from a distance, and may be radiated to the second solution discharged onto a portion of the first glass portion GS1 from nearby. Accordingly, the second solution discharged onto the second glass portion GS2 may have a lower degree of hardening than the second solution discharged onto a portion of the first glass portion GS1. Therefore, when the second organic layer OL2 formed from the second solution is removed, the second organic layer OL2 may be easily removed.

According to an embodiment, the second organic layer OL2 may include a polymer that may not be dissolved in water, i.e., a water-insoluble polymer. For example, the second solution may include a second monomer having nor or a small number of hydrophilic groups such as an alcohol group, a sulfonic acid group, a carboxylic acid group, and a phosphoric acid group, and/or a second polymer formed by polymerizing the second monomer. For example, the second solution may include at least one of polystyrene, polymethyl methacrylate, novolac resin, polyimide, epoxy resin, acrylic resin, polyvinylphenol, polyhydroxystyrene, cycloolefin polymer, and polycarbonate. Accordingly, the second organic layer OL2, which is a cured product of the second solution, may not be dissolved in water. However, embodiments are not limited thereto.

According to an embodiment, the second solution may further include a UV absorbing material. For example, the UV absorbing material may include at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound. When the second solution discharged onto (i.e., on) the glass substrate GS is irradiated with UV light, the UV absorbing material included in the second solution may absorb the UV light from an upper portion of the second solution, and thus may reduce the amount of UV light reaching a lower portion of the second solution, i.e., the vicinity of an interface with the glass substrate GS. Accordingly, the lower portion of the second solution may have a relatively low degree of hardening, compared to the upper portion thereof. Therefore, when the second organic layer OL2 formed from the second solution is removed, the second organic layer OL2 may be easily removed.

In FIG. 5, edges of one side and the other side of the first organic layer OL1 are illustrated as being covered by the second organic layer OL2 with the same size (e.g., the same area). That is, in FIG. 5, a length of the second organic layer OL2 protruding from one side of the first organic layer OL1 toward the center of the first organic layer OL1 is illustrated as being the same as a length of the second organic layer OL2 protruding from the other side of the first organic layer OL1 toward the center of the first organic layer OL1. However, embodiments are not limited thereto. For example, a size (e.g., an area) of the second organic layer OL2 covering the edge of the one side of the first organic layer OL1 may be different from a size (e.g., an area) of the second organic layer OL2 covering the edge of the other side of the first organic layer OL1.

Although it has been described above with reference to FIGS. 4 and 5 that both the first solution and the second solution are discharged via inkjet printing, embodiments are not limited thereto. For example, only one of the first solution and the second solution may be discharged via inkjet printing, and the other of the first solution and the second solution may be discharged using a discharge method other than inkjet printing. In this regard, in at least one of the first organic layer forming operation S100 and the second organic layer forming operation S200, the first solution or the second solution may be discharged via inkjet printing.

In the first organic layer removing operation S300, referring to FIG. 6, the first organic layer OL1 may be removed. In this regard, the controller CO may control the removal device EL to remove the first organic layer OL1. In detail, the first organic layer OL1 may be dissolved by spraying a first solvent onto the first organic layer OL1. Accordingly, the first organic layer OL1 may be removed. In this regard, the controller CO may control the removal device EL to spray the first solvent onto the first organic layer OL1. The controller CO may control the removal device EL to remove the first organic layer OL1 by using the first solvent.

According to an embodiment, the first solvent may include water. As described above, the first organic layer OL1 may include a polymer that may be dissolved in water, and thus, the first organic layer OL1 may be dissolved by the first solvent. The second organic layer OL2 may include a polymer that may not be dissolved in water. Accordingly, because the second organic layer OL2 does not dissolve in water, the second organic layer OL2 may not be removed in the first organic layer removing operation S300. In this regard, the controller CO may control the removal device EL to remove the first organic layer OL1 by using the first solvent and not remove the second organic layer OL2. Thus, the second organic layer OL2 may remain on the glass substrate GS after the first organic layer removing operation S300.

According to an embodiment, the first solvent may further include an organic solvent. The organic solvent may include at least one of acetone, methyl ethyl ketone, dimethyl sulfoxide, N-methyl-2-pyrrolidone, isopropyl alcohol, ethanol, and butanol.

According to an embodiment, the first solvent may include at least one of an inorganic acid and an organic acid. For example, the inorganic acid may include at least one of hydrochloric acid (HCl), sulfuric acid (H₂SO₄), nitric acid (HNO₃), hydrofluoric acid (HF), and phosphoric acid (H₃PO₄), and the organic acid may include at least one of acetic acid, malic acid, citric acid, and oxalic acid. According to an embodiment, the first solvent may further include at least one of ammonium fluoride (NH₄F), sodium fluoride (NaF), and potassium fluoride (KF).

According to an embodiment, the first solvent may further include a surfactant. The surfactant may include at least one of an anionic surfactant, a cationic surfactant, and a non-ionic surfactant. According to an embodiment, the first solvent may further include a defoaming agent. However, embodiments are not limited thereto.

The second-1 organic portion OL21 of the second organic layer OL2 is disposed apart from the first glass portion GS1 along a thickness direction (e.g., a z-axis direction) of the glass substrate GS, and, in the first organic layer removing operation S300, a portion of the first organic layer OL1 existing between the second-1 organic portion OL21 of the second organic layer OL2 and the first glass portion GS1 is removed. Accordingly, a groove structure defined by a lower surface of the second-1 organic portion OL21 and an upper surface of the first glass portion GS1 may be formed by a space where a portion of the first organic layer OL1 has been removed. That is, a groove structure defined by the lower surface of the second organic layer OL2 and the upper surface of the glass substrate GS may be formed.

In the glass substrate etching operation S400, referring to FIG. 7, the first glass portion GS1 may be etched. In the glass substrate etching operation S400, a portion of the second glass portion GS2 that is adjacent to the first glass portion GS1 may also be etched. In this regard, the controller CO may control the removal device EL to etch the first glass portion GS1 and the portion of the second glass portion GS2 adjacent to the first glass portion GS1.

In detail, the upper surface of the first glass portion GS1 may be etched by spraying an etchant onto the first glass portion GS1. As described above, a groove structure defined by a lower surface of the second-1 organic portion OL21 and an upper surface of the first glass portion GS1 may be formed in the first organic layer removing operation S300. Accordingly, in the glass substrate etching operation S400, the etchant may also contact the portion of the second glass portion GS2 that is adjacent to the first glass portion GS1. Accordingly, the portion of the second glass portion GS2 that is adjacent to the first glass portion GS1 may also be etched. Accordingly, the glass substrate GS may define a groove G as illustrated in FIG. 7.

In this case, in a portion of the first glass portion GS1 that does not overlap the second-1 organic portion OL21, the flow of the etchant may be fast and an etching rate may be high. However, in a portion of the first glass portion GS1 that overlaps the second-1 organic portion OL21, the flow of the etchant may be slow and an etching rate may be low. Due to this difference in etching rate, a lateral surface of the groove G may be formed gently. That is, in a region adjacent to the boundary between the first glass portion GS1 and the second glass portion GS2, an angle θ formed by the lateral surface of the groove G and a surface parallel to a bottom surface of the groove G may be small. For example, the angle θ may be less than 45 degrees.

According to an embodiment, the etchant may include at least one of hydrofluoric acid (HF), ammonium fluoride (NH₄F), sodium fluoride (NaF), potassium fluoride (KF), hydrochloric acid (HCl), nitric acid (HNO₃), phosphoric acid (H₃PO₄), acetic acid (CH₃COOH), and mixtures thereof. However, embodiments are not limited thereto.

In the second organic layer removing operation S500, referring to FIG. 8, the second organic layer OL2 may be removed. In this regard, the controller CO may control the removal device EL to remove the second organic layer OL2. In detail, the second organic layer OL2 may be dissolved by spraying a second solvent onto the second organic layer OL2. Accordingly, the second organic layer OL2 may be removed. In this regard, the controller CO may control the removal device EL to spray the second solvent onto the second organic layer OL2. The controller CO may control the removal device EL to remove the second organic layer OL2 by using the second solvent.

According to an embodiment, the second solvent may be an organic solvent. As described above, the second organic layer OL2 may include a polymer that may not be dissolved in water, and the second organic layer OL2 may be dissolved by the organic solvent. The organic solvent may include at least one of acetone, methyl ethyl ketone, dimethyl sulfoxide, N-methyl-2-pyrrolidone, isopropyl alcohol, ethanol, and butanol. Alternatively, the second solvent may be an alkaline solution. The alkaline solution may include at least one of tetramethylammonium hydroxide, potassium hydroxide, sodium hydroxide, and choline. However, embodiments are not limited thereto.

According to an embodiment, in at least one of the first organic layer removing operation S300 and the second organic layer removing operation S500, at least one of heating and ultrasonic vibration may be used when the first organic layer OL1 or the second organic layer OL2 is removed. The ultrasonic vibration may include a megasonic vibration. For example, when the first organic layer OL1 is heated or ultrasonic vibration is applied to the first organic layer OL1, the first organic layer OL1 may be removed using the first solvent including water. Alternatively, when the second organic layer OL2 is heated or ultrasonic vibration is applied to the second organic layer OL2, the second organic layer OL2 may be removed using the second solvent, which is an organic solvent. In this regard, the removal device EL may use at least one of heating and ultrasonic vibration when removing the first organic layer OL1 or the second organic layer OL2.

When at least one of heating and ultrasonic vibration is used, removal of the first organic layer OL1 or the second organic layer OL2 may be promoted. In particular, when at least one of heating and ultrasonic vibration is used to remove the first organic layer OL1, a portion of the first organic layer OL1 existing between the second-1 organic portion OL21 of the second organic layer OL2 and the first glass portion GS1 may be easily removed.

In general, when the glass substrate GS is etched after the second organic layer OL2 is formed on the glass substrate GS without forming the first organic layer OL1, the lateral surface of the groove G of the glass substrate GS may be formed steeply. That is, the angle formed by the lateral surface of the groove G and the surface parallel to the bottom surface of the groove G may increase.

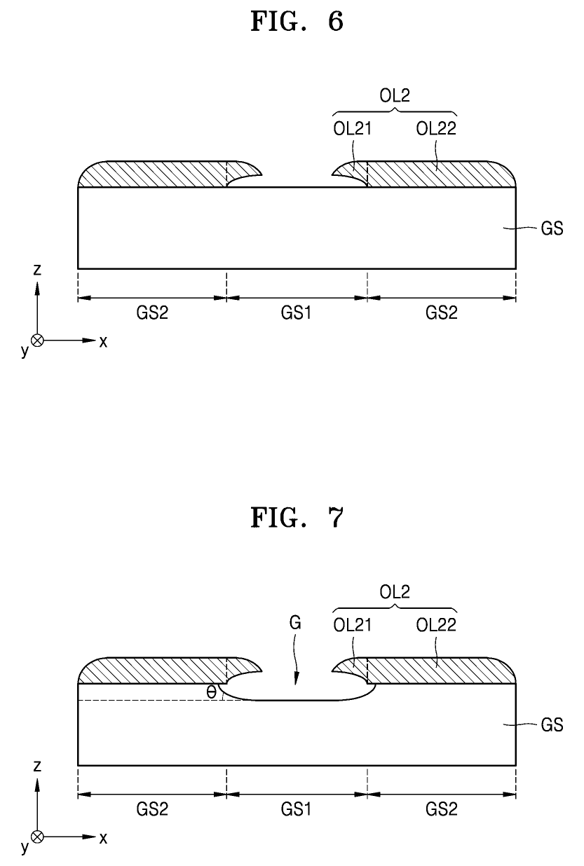

FIGS. 9 and 10 are views for explaining a glass processing method according to a comparative example.

In general, when the second organic layer OL2 is formed on the glass substrate GS without forming the first organic layer OL1, all of the second organic layer OL2 is in contact with the glass substrate GS as illustrated in FIG. 9. Accordingly, a groove structure defined by the lower surface of the second organic layer OL2 and the upper surface of the glass substrate GS may not be formed. Therefore, there is no portion of the glass substrate GS where the flow of the etchant is slow and the etching rate is low. Accordingly, as illustrated in FIG. 10, an angle θ’ formed by a surface parallel to a bottom surface of a groove G and a lateral surface of the groove G may be greater than the angle θ of FIG. 7. That is, the lateral surface of the groove G of the glass substrate GS may be formed steeply (i.e., the angle θ’ may not be less than 45 degrees.

However, in the glass processing method according to embodiments, the first organic layer OL1 is formed on the glass substrate GS, the second organic layer OL2 is formed to cover at least a portion of the first organic layer OL1, and, after the first organic layer OL1 is removed, the glass substrate GS is etched. Accordingly, a groove structure defined by the lower surface of the second-1 organic portion OL21 and the upper surface of the first glass portion GS1 is formed. Therefore, there is a portion of the glass substrate GS where the flow of the etchant is slow and the etching rate is low. Accordingly, as illustrated in FIG. 7, the angle θ formed by the surface parallel to the bottom surface of the groove G and the lateral surface of the groove G may be relatively small. That is, the lateral surface of the groove G of the glass substrate GS may be formed gently. That is, glass may be easily etched into a preset shape.

In FIG. 5, a thickness of the second-1 organic portion OL21 is illustrated as being formed to be less than or equal to a thickness of the second-2 organic portion OL22. However, embodiments are not limited thereto.

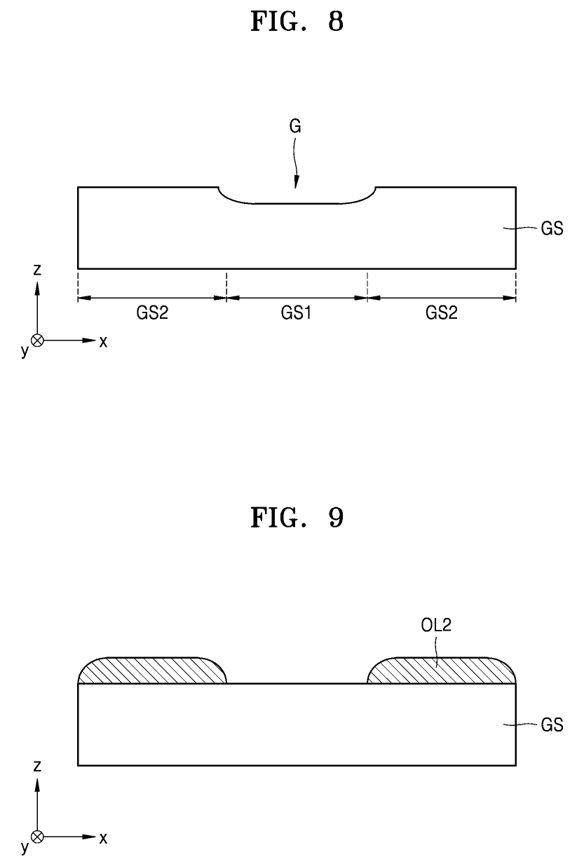

FIG. 11 is a view for explaining a glass processing method according to an embodiment. FIG. 11 corresponds to FIG. 5. That is, FIG. 11 illustrates the second organic layer forming operation S200.

As illustrated in FIG. 11, in the second organic layer forming operation S200, the second organic layer OL2 may be formed so that the second-1 organic portion OL21 is thicker than the second-2 organic portion OL22. In this regard, the controller CO may control the discharge device DI and the irradiation device IR so that the second-1 organic portion OL21 is thicker than the second-2 organic portion OL22. That is, in the second organic layer forming operation S200, the second-1 organic portion OL21 may have a first thickness T21, and the second-2 organic portion OL22 may have a second thickness T22. The first thickness T21 may be greater than the second thickness T22. In this specification, a thickness of a portion of the second organic layer refers to a maximum length measured at the portion of the second organic layer in a thickness direction (e.g., the z-axis direction) of the glass substrate GS.

When the first thickness T21 is too small, it may not be easy for the second-1 organic portion OL21 to maintain structural stability after the first organic layer removing operation S300. For example, the second-1 organic portion OL21 may be deformed or collapsed and tilted toward the glass substrate GS. Accordingly, the glass substrate GS may not be etched into a preset shape. When the second thickness T22 is too large, it may not be easy to remove the second-2 organic portion OL22 of the second organic layer OL2 in the second organic layer removing operation S500.

However, in the glass processing method according to embodiments, in the second organic layer forming operation S200, the second organic layer OL2 is formed such that the first thickness T21 of the second-1 organic portion OL21 is greater than the second thickness T22 of the second-2 organic portion OL22. That is, the first thickness T21 of the second-1 organic portion OL21 is greater than the second thickness T22 of the second-2 organic portion OL22. Accordingly, after the first organic layer removing operation S300, the second-1 organic portion OL21 may have sufficient structural rigidity to stably maintain its shape. In addition, the second-2 organic portion OL22 may be formed relatively thinly and thus may be easily removed in the second organic layer removing operation S500.

In FIG. 4, it is illustrated that the first organic layer OL1 is formed on a portion of the glass substrate GS that is to be etched in the glass substrate etching operation S400. However, embodiments are not limited thereto.

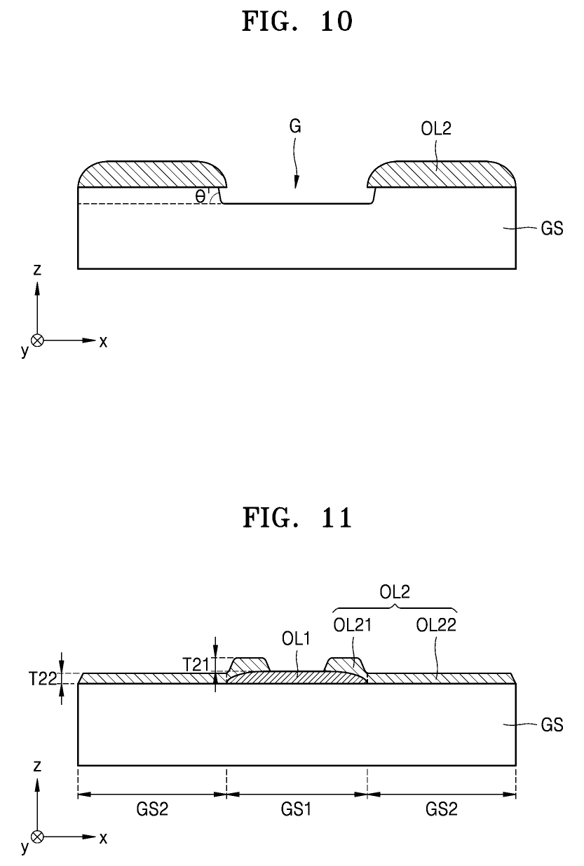

FIGS. 12 and 13 are views for explaining a glass processing method according to an embodiment. FIG. 12 corresponds to FIG. 4, and FIG. 13 corresponds to FIG. 5. That is, FIG. 12 illustrates the first organic layer forming operation S100, and FIG. 13 illustrates the second organic layer forming operation S200.

As illustrated in FIG. 12, the glass substrate GS may further include a third glass portion GS3. The third glass portion GS3, which is a portion between first glass portions GS1, may be a portion where the first organic layer OL1 and the second organic layer OL2 are not to be formed. That is, the third glass portion GS3 may be a portion that does not directly contact both the first organic layer OL1 and the second organic layer OL2. For example, a portion of the first glass portion GS1 may be disposed on one side of the third glass portion GS3, and another portion of the first glass portion GS1 may be disposed on the other side of the third glass portion GS3. The first organic layer OL1 may not be formed on the third glass portion GS3 of the glass substrate GS.

As illustrated in FIG. 13, the second organic layer OL2 may cover at least a portion of the first organic layer OL1 disposed on one side of the third glass portion GS3. The second organic layer OL2 may also cover the other portion of the first organic layer OL1 disposed on the other side of the third glass portion GS3. In detail, edges located farther from the third glass portion GS3 among the edges of the first organic layer OL1 may be covered by the second organic layer OL2, and edges located closer to the third glass portion GS3 among the edges of the first organic layer OL1 may not be covered by the second organic layer OL2.

In this case, the amount of the first solution used in the first organic layer forming operation S100 may be reduced. Accordingly, glass processing costs may be reduced and a glass processing time may be reduced.

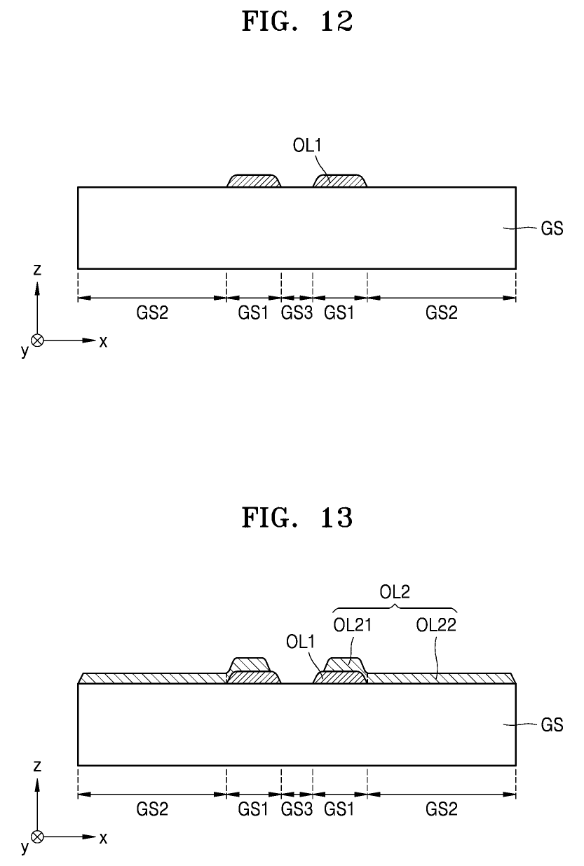

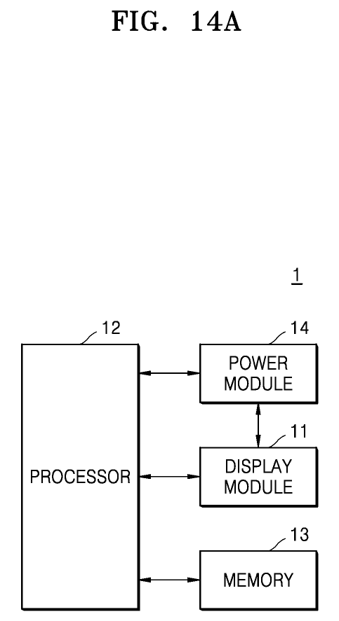

FIG. 14A is a schematic block diagram of an electronic apparatus 1 manufactured according to an embodiment. The electronic apparatus 1 may further include, for example, modules having other additional functions in addition to a display module 11. For example, as shown in FIG. 14A, the electronic apparatus 1 may include the display module 11, a processor 12, a memory 13, and a power module 14. The display module 11 may include a display panel and control circuitry.

The processor 12 may control the components of the electronic apparatus 1. The processor 12 may include at least one of a central processing unit (CPU), an application processor (AP), a graphics processing unit (GPU), a communication processor (CP), an image signal processor (ISP), and a controller.

The memory 13 may store data information necessary for an operation of the processor 12 or the display module 11. When the processor 12 executes an application stored in the memory 13, an input control signal and/or a data signal for an image may be transmitted to the display module 11, and the display module 11 may process the received signal and output image information.

The power module 14 may include power supply circuitry, such as a power adapter or a battery device, and power conversion circuitry that converts power supplied by the power supply module to generate power necessary for an operation of the electronic apparatus 1.

FIG. 14B is a schematic diagram of electronic apparatuses 1 manufactured according to embodiments. Referring to FIG. 14B, the electronic apparatuses 1 each including the display module 11 may include not only image display electronic apparatuses (such as, a smartphone 1a, a tablet PC 1b, a laptop 1c, a TV 1d, and a desk monitor 1e), but also wearable electronic apparatuses including display modules (such as, smart glasses 1f, a head mounted display 1g, and a smart watch 1h), and vehicle electronic apparatuses 1i including display modules (such as, a center information display (CID) disposed on an instrument panel, center fascia, or dashboard of automobiles, and a room mirror display).

The display module 11 may include a display apparatus 10 (see FIG. 2). The display apparatus 10 may be applied to various electronic apparatuses 1. In this regard, the electronic apparatus 1 may include the display apparatus 10, and may further include a module or device having other additional functions in addition to the display apparatus 10. For example, the electronic apparatus 1 may include the display apparatus 10, the processor 12, the memory 13, and the power module 14, and the display apparatus 10 may be controlled by the processor 12. The display apparatus 10 will now be focused on and described.

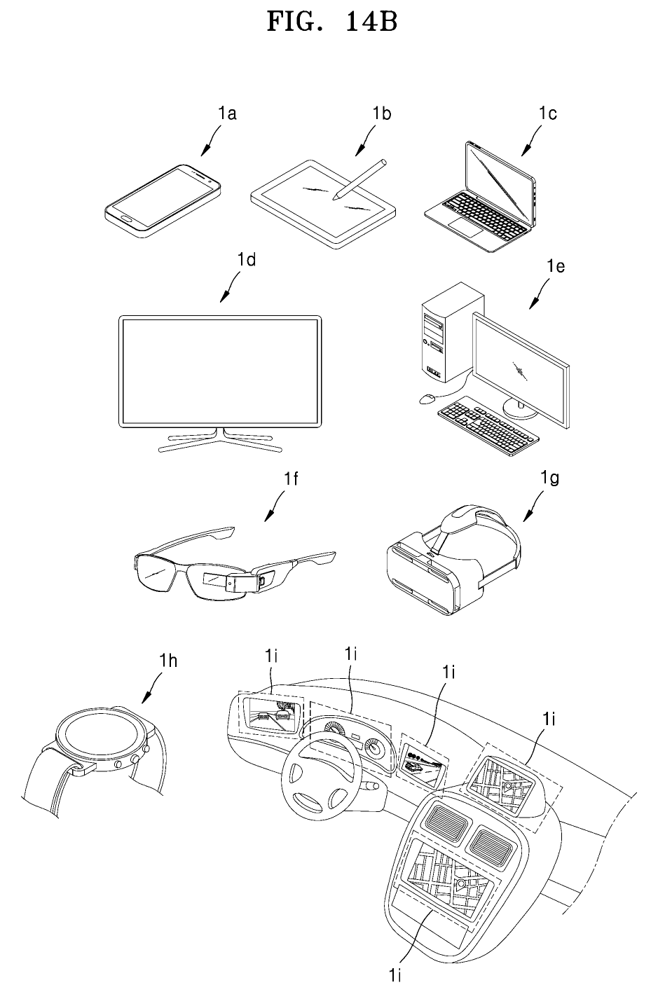

FIG. 15 is a schematic perspective view of a display apparatus 10 included in the electronic apparatus 1 manufactured according to an embodiment. As shown in FIG. 15, the display apparatus 10 may have a polygonal shape including a quadrangle. For example, the display apparatus 10 may have a rectangular shape in which a horizontal length is less than a vertical length, a rectangular shape in which a horizontal length is greater than a vertical length, or a square shape. Alternatively, the display apparatus 10 may have any of various shapes such as an oval or a circle. Although the display apparatus 10 is illustrated in FIG. 15 as having a rectangular shape in which a horizontal length is less than a vertical length, embodiments are not limited thereto.

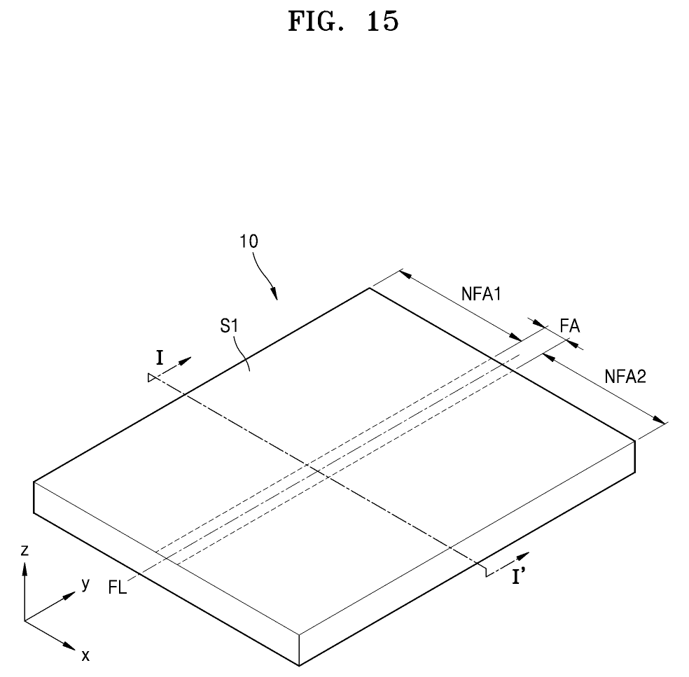

The display apparatus 10 may include a first surface S1 and a second surface S2 (see FIG. 16) that is opposite to the first surface S1. The display apparatus 10 may display an image on the first surface S1. In this regard, the first surface S1 may include a display surface. According to an embodiment, the first surface S1 may be an upper surface (in a +z direction) of the display apparatus 10. The second surface S2 may be a lower surface (in a -z direction) of the display apparatus 10. According to an embodiment, the display apparatus 10 may also display an image on the second surface S2.

The display apparatus 10 may be foldable. In this regard, at least a portion of the display apparatus 10 may have flexibility, and the display apparatus 10 may be folded as the portion having flexibility is bent. For example, as shown in FIG. 16, which is a side view of the display apparatus 10 included in the electronic apparatus 1 manufactured according to an embodiment, the display apparatus 10 may be folded. In this regard, FIG. 15 is a perspective view of the display apparatus 10 in an unfolded state, and FIG. 16 is a side view of the display apparatus 10 in a folded state.

Accordingly, the display apparatus 10 may include a folded area and a non-folded area that is provided on at least one side of the folded area and is not folded. The expression “non-folded” used herein means that a portion is not folded, and covers not only a case where a portion is hard with no flexibility and thus is not folded, but also a case where a portion has flexibility but is not folded. The display apparatus 10 may display an image not only in the non-folded area but also in the folded area.

Referring to FIG. 15, the display apparatus 10 may include a first non-folding area NFA1, a second non-folding area NFA2, and a foldable area FA. The first non-folding area NFA1 and the second non-folding area NFA2 may be non-folded areas, and the foldable area FA may have flexibility and may be a foldable area.

The foldable area FA may be arranged between the first non-folding area NFA1 and the second non-folding area NFA2. In detail, the first non-folding area NFA1 may be adjacent to one side of the foldable area FA, and the second non-folding area NFA2 may be adjacent to the other side of the foldable area FA. The foldable area FA may extend in a direction intersecting a virtual straight line that connects the first non-folding area NFA1 to the second non-folding area NFA2.

In detail, the foldable area FA may extend in a first direction (e.g., a y-axis direction). When the display apparatus 10 is unfolded, the first non-folding area NFA1 and the second non-folding area NFA2 may be apart from each other in a second direction (for example, an x-axis direction) intersecting the first direction (e.g., the y-axis direction). Even when the display apparatus 10 is folded, the virtual straight line (e.g., a straight line parallel to the z-axis direction) that connects the first non-folding area NFA1 to the second non-folding area NFA2 may intersect the first direction (e.g., the y-axis direction). In this regard, the foldable area FA may extend in a direction intersecting the virtual straight line that connects the first non-folding area NFA1 to the second non-folding area NFA2.

A folding line FL may be provided in the foldable area FA and may extend in the second direction (e.g., the y-axis direction) in which the foldable area FA extends. Accordingly, the display apparatus 10 may be folded in the foldable area FA. The foldable area FA and the folding line FL of the foldable area FA may overlap a portion of the display apparatus 10 where an image is displayed, and, when the display apparatus 10 is folded, the portion where an image is displayed may be folded.

Although the first non-folding area NFA1 and the second non-folding area NFA2 have the same area or similar areas and the display apparatus 10 includes one foldable area FA in FIG. 15 for convenience of description, one or more embodiments are not limited thereto. For example, the first non-folding area NFA1 and the second non-folding area NFA2 may have different areas from each other. In addition, the display apparatus 10 may include a plurality of foldable areas FA. In this case, a plurality of non-folding areas may be apart from each other, and each of the plurality of foldable areas FA may be arranged between the non-folding areas. Each foldable area FA may be folded along the folding line FL, and a plurality of folding lines FL may be provided.

Although the folding line FL passes through the center of the foldable area FA and the foldable area FA is line-symmetric with respect to the folding line FL in FIG. 1, one or more embodiments are not limited thereto. For example, the folding line FL may be asymmetrically provided in the foldable area FA.

As shown in FIG. 16, the display apparatus 10 may be folded along the folding line FL such that the first surface S1 of the first non-folding area NFA1 and the first surface S1 of the second non-folding area NFA2 may face each other. In this regard, as the foldable area FA of the display apparatus 10 is bent, the first surface S1 of the first non-folding area NFA1 and the first surface S1 of the second non-folding area NFA2 may be arranged to face each other. The foldable area FA may be bent and then may be unfolded again. That is, the display apparatus 10 may be a foldable display apparatus.

The expression “folded” used herein means that a portion is not fixed in shape but is transformed from an original shape to another shape, and may be folded, curved, or bent along at least one specific line, such as the folding line FL. Accordingly, although FIG. 16 shows that the display apparatus 10 is folded such that the first surface S1 of the first non-folding area NFA1 and the first surface S1 of the second non-folding area NFA2 are parallel to each other and face each other, one or more embodiments are not limited thereto. For example, the display apparatus 10 may be folded such that the first surface S1 of the first non-folding area NFA1 and the first surface S1 of the second non-folding area NFA2 may form a certain angle (e.g., an acute angle, a right angle, and/or an obtuse angle) with the foldable area FA therebetween.

In addition, although FIG. 16 shows that the display apparatus 10 is folded such that a portion of the first surface S1 and another portion of the first surface S1 face each other, that is, is in-folded, one or more embodiments are not limited thereto. For example, the display apparatus 10 may be folded such that a portion of the second surface S2 and another portion of the second surface S2 face each other, that is, may be out-folded. In this regard, the display apparatus 10 may be of an in-folding type in which portions of a display surface face each other when the display apparatus 10 is folded, or may be of an out-folding type in which a display surface is exposed to the outside when the display apparatus 10 is folded. That is, the display apparatus 10 may be folded such that a portion of one side of the display apparatus 10 and another portion of the one side face each other. For convenience of description, a case where the display apparatus 10 is of an in-folding type will now be focused on and described.

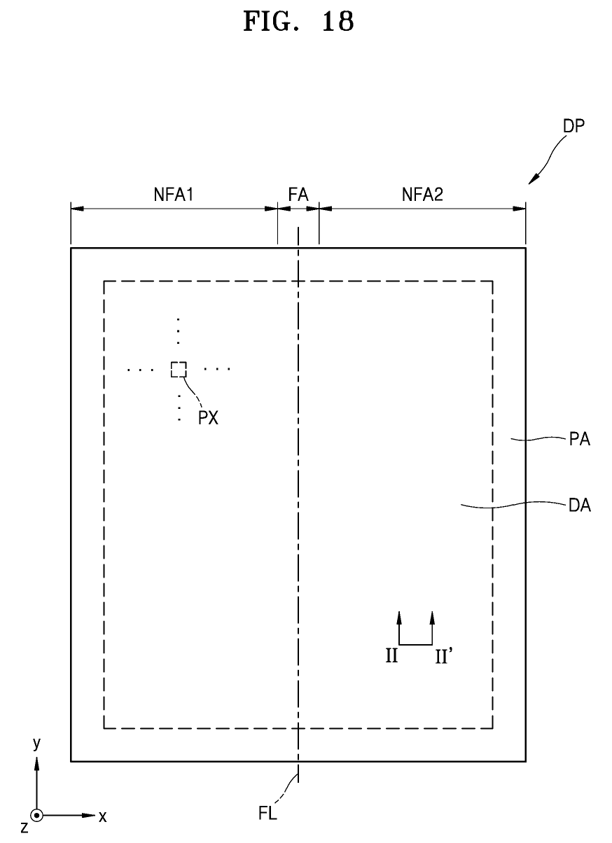

FIG. 17 is a schematic cross-sectional view of the display apparatus 10 of FIG. 15 taken along line I-I’. FIG. 18 is a schematic plan view of a display panel DP included in the display apparatus 10 of FIG. 17. Referring to FIG. 17, the display apparatus 10 may include the display panel DP and a cover window CW. As necessary, the display apparatus 10 may further include various other elements than the elements shown in FIG. 17.

The display panel DP may display an image. That is, an image provided by the display apparatus 10 may be understood as being implemented by the display panel DP. To this end, the display panel DP may include a plurality of display elements, and the plurality of display elements may emit light. Accordingly, the display panel DP may display an image through the light emitted by the plurality of display elements.

According to an embodiment, the display element may be an organic light-emitting diode including an organic emission layer. Alternatively, the display element may be a light-emitting diode (LED). The size of the LED may be microscale or nanoscale. For example, the light-emitting diode may be a micro light-emitting diode. As another example, the LED may be a nanorod LED. The nanorod LED may include gallium nitride (GaN). According to an embodiment, a color converting layer may be arranged on the nanorod LED. The color converting layer may include quantum dots. Alternatively, the display element may be a quantum dot light-emitting diode including a quantum dot emission layer. Alternatively, the display element may be an inorganic light-emitting diode including an inorganic semiconductor. Elements included in the display panel DP will be described later in more detail.

As described above, the display apparatus 10 may include the first non-folding area NFA1, the second non-folding area NFA2, and the foldable area FA. Because the display apparatus 10 includes the display panel DP, it may be considered that the display panel DP may include the first non-folding area NFA1, the second non-folding area NFA2, and the foldable area FA as described above. For convenience of explanation, the display panel DP will now be described as having the first non-folding area NFA1, the second non-folding area NFA2, and the foldable area FA.

That is, the foldable area FA may be arranged between the first non-folding area NFA1 and the second non-folding area NFA2, and may extend in a direction intersecting the virtual straight line that connects the first non-folding area NFA1 to the second non-folding area NFA2. In detail, the foldable area FA may extend in the first direction (e.g., the y-axis direction). When the display panel DP is unfolded, the first non-folding area NFA1 and the second non-folding area NFA2 may be apart from each other in the second direction (for example, the x-axis direction) intersecting the first direction (e.g., the y-axis direction). Even when the display panel DP is folded, the virtual straight line (e.g., a straight line parallel to the z-axis direction) that connects the first non-folding area NFA1 to the second non-folding area NFA2 may intersect the first direction (e.g., the y-axis direction). A folding line FL may be provided in the foldable area FA and may extend in the second direction (e.g., the y-axis direction) in which the foldable area FA extends. Accordingly, the display panel DP may be folded in the foldable area FA.

As shown in FIG. 18, the display panel DP may include a display area DA in which a plurality of pixels PX are arranged, and a peripheral area PA located outside the display area DA.

Each of the plurality of pixels PX of the display panel DP is an area capable of emitting light of a certain color, and the display panel DP may provide an image by using light emitted by the plurality of pixels PX. For example, each of the plurality of pixels PX may emit red light, green light, or blue light. That is, one display element may correspond to one pixel.

The display area DA, which is an area that provides an image, may have a polygonal shape including a quadrangle, as shown in FIG. 18. For example, the display area DA may have a rectangular shape in which a horizontal length is greater than a vertical length, a rectangular shape in which a horizontal length is less than a vertical length, or a square shape. Alternatively, the display area DA may have any of various shapes such as an oval or a circle.

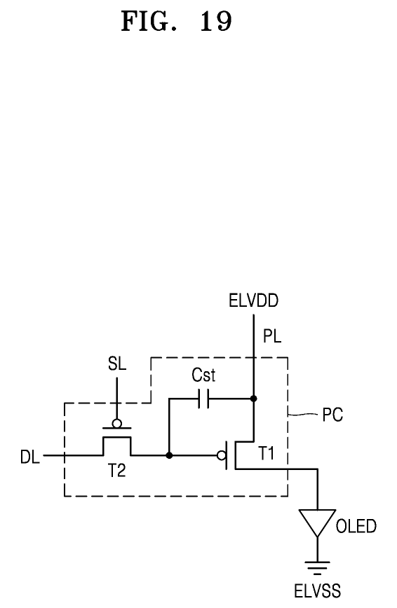

The peripheral area PA is a non-display area that provides no images, and may surround the entirety of the display area DA. In detail, pixels PX are not arranged in the peripheral area PA, and a driver or the like for providing an electrical signal or power to the pixels PX may be arranged in the peripheral area PA. Pads may be arranged in the peripheral area PA, and an electronic apparatus or a printed circuit board may be electrically connected to the pads. Each of the pads may be apart from another in the peripheral area PA, and may be electrically connected to a plurality of connection wires arranged in the peripheral area PA. The connection wires may electrically connect signal lines arranged in the display area DA, for example, data lines DL of FIG. 19 (or scan lines SL of FIG. 19), to the pads.

The cover window CW may be arranged on the display panel DP. In detail, the cover window CW may be disposed on an upper surface (e.g., in the +z direction) of the display panel DP. The front surface of the display panel DP may be defined as a surface that faces a direction in which the display panel DP provides an image. According to an embodiment, the cover window CW may be arranged to cover the upper surface of the display panel DP. The cover window CW may protect the upper surface of the display panel DP. Because the cover window CW forms the exterior of the display apparatus 10, the cover window CW may include a flat surface and a curved surface corresponding to the shape of the display apparatus 10.

The cover window CW may have a high transmittance to transmit light emitted by the display panel DP, and may have a small thickness to minimize a weight of the display apparatus 10. The cover window CW may also have high strength and hardness to protect the display panel DP from external impacts. The cover window CW may be a flexible window. The cover window CW may protect the display panel DP while being easily bent along an external force without generating cracks or the like.

The cover window CW may include glass. For example, the cover window CW may be ultra-thin tempered glass (ultra-thin glass, UTG®) having a strength enhanced by a method such as chemical strengthening or thermal strengthening. An image displayed by the display panel DP may be provided to a user through the cover window CW having transparency. That is, an image provided by the display apparatus 10 may be understood as being implemented by the display panel DP.

The cover window CW may define a groove G. That is, the cover window CW may be formed by etching the glass substrate GS. In detail, the first organic layer OL1 having a shape corresponding to the groove G may be formed on the first glass portion GS1 of the glass substrate GS, and the second organic layer OL2 may be formed on the second glass portion GS2 of the glass substrate GS that is in contact with (i.e., adjacent) the first glass portion GS1. The formed second organic layer OL2 may cover at least a portion of the first organic layer OL1. Next, after the first organic layer OL1 is removed, the glass substrate GS may be etched. Then, the second organic layer OL2 may be removed to form the cover window CW. That is, the etched glass substrate GS in embodiments described above with reference to FIGS. 1 - 8, 11, 12, and 13 may correspond to the cover window CW.

The groove G may overlap the foldable area FA of the display panel DP. Accordingly, when the display panel DP is folded, a repulsive force of the cover window CW may be reduced. Thus, the display panel DP may be easily folded.

In some embodiments, the display apparatus 10 may further include an adhesive layer. This adhesive layer may be disposed between the display panel DP and the cover window CW of the display apparatus 10 so as to attach the cover window CW to the display panel DP. For example, the adhesive layer may be an optically clear adhesive (OCA) or a pressure sensitive adhesive (PSA).

FIG. 19 is an equivalent circuit diagram of a pixel circuit PC included in the display panel DP of FIG. 18. The pixel circuit PC may be electrically connected to a display element, and one display element may correspond to one pixel PX. In FIG. 19, an organic light-emitting diode OLED is shown as a display element. According to an embodiment, the display element may emit red light, green light, or blue light.

The pixel circuit PC may include a first transistor T1, a second transistor T2, and a storage capacitor Cst. The second transistor T2, which is a switching transistor, may be connected to a scan line SL and a data line DL, and may be turned on by a switching signal received from the scan line SL to transmit, to the first transistor T1, a data signal received from the data line DL. The storage capacitor Cst may have one end electrically connected to the second transistor T2 and the other end electrically connected to a driving voltage line PL, and may store a voltage corresponding to a difference between a voltage received from the second transistor T2 and a driving power supply voltage ELVDD supplied to the driving voltage line PL.

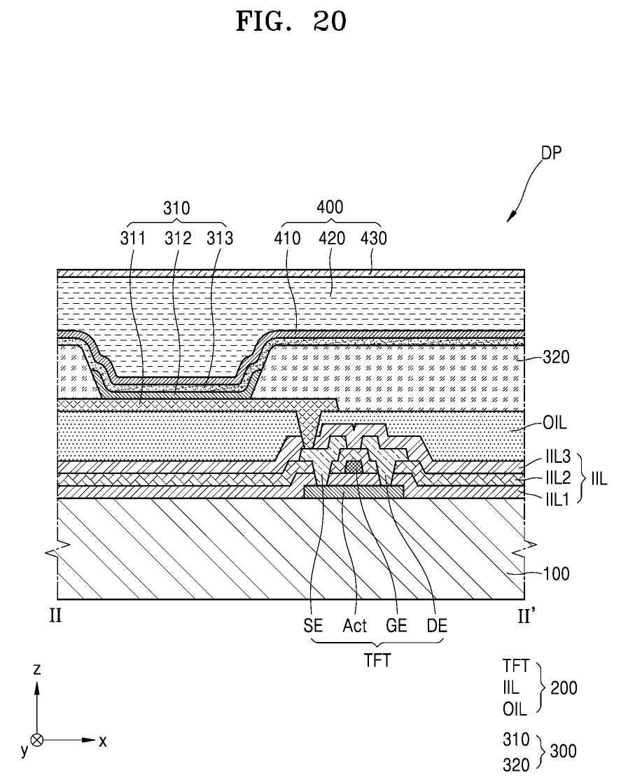

The first transistor T1, which is a driving transistor, may be connected to the driving voltage line PL and the storage capacitor Cst, and may be configured to control the magnitude of a driving current flowing from the driving voltage line PL to the organic light-emitting diode OLED, in accordance with a voltage value stored in the storage capacitor Cst. The organic light-emitting diode OLED may emit light having a certain brightness due to the driving current. An opposite electrode 313 (see FIG. 20) of the organic light-emitting diode OLED may receive an electrode power supply voltage ELVSS.

Although FIG. 19 illustrates that the pixel circuit PC includes two transistors and one storage capacitor, one or more embodiments are not limited thereto. For example, the number of transistors or the number of storage capacitors may vary according to a design of the pixel circuit PC.

FIG. 20 is a schematic cross-sectional view of the display panel DP of FIG. 18 taken along line II-II’. Referring to FIG. 20, the display panel DP may include a substrate 100, a pixel circuit layer 200, a display element layer 300, and an encapsulation layer 400.

The substrate 100 may include glass, a metal, or a polymer resin. The substrate 100 needs to have flexible or bendable characteristics. In this case, the substrate 100 may include polymer resin such as polyethersulfone, polyacrylate, polyetherimide, polyethylene naphthalate, polyethylene terephthalate, polyphenylene sulfide, polyarylate, polyimide, polycarbonate, or cellulose acetate propionate. The substrate 100 may have a multi-layered structure including two layers each including a polymer resin and a barrier layer including an inorganic material (silicon oxide (SiO_{X}), silicon nitride (SiN_{X}), silicon oxynitride (SiO_{X}N_{Y}), or the like) and located between the two layers. In this way, various modifications may be made.

The pixel circuit layer 200 may be disposed on the substrate 100. The pixel circuit layer 200 may include a transistor TFT, an inorganic insulating layer IIL, and an organic insulating layer OIL. The transistor TFT may include a semiconductor layer Act, a gate electrode GE, a source electrode SE, and a drain electrode DE. The inorganic insulating layer IIL may include a gate insulating layer IIL1, a first interlayer insulating layer IIL2, and a second interlayer insulating layer IIL3. For convenience of illustration, one transistor TFT is shown in FIG. 20, and the transistor TFT may correspond to the above-described first transistor T1 of FIG. 19.

The semiconductor layer Act may be arranged on the substrate 100. The semiconductor layer Act may include polysilicon. Alternatively, the semiconductor layer Act may include amorphous silicon, an oxide semiconductor, or an organic semiconductor. According to an embodiment, the semiconductor layer Act may include a channel region, and a source region and a drain region respectively arranged on both sides of the channel region.

The gate insulating layer IIL1 may be disposed on the semiconductor layer Act and the substrate 100. The gate insulating layer IIL1 may include an inorganic insulating material such as silicon oxide (SiO_{X}), silicon nitride (SiN_{X}), or silicon oxynitride (SiO_{X}N_{Y}). For example, the gate insulating layer IIL1 may have a single-layer or multi-layer structure including the above-mentioned material. As such, an insulating layer including an inorganic insulating material may be formed via a method such as chemical vapor deposition (CVD). This is equally applied to embodiments to be described later and modifications thereof.

In FIG. 20, the gate insulating layer IIL1 is illustrated as having a shape corresponding to the entire surface of the substrate 100 and having a structure in which contact holes are formed in a preset portion of the gate insulating layer IIL1. However, embodiments are not limited thereto. For example, the gate insulating layer IIL1 may be patterned in the same shape as the gate electrode GE.

The gate electrode GE may be disposed on the gate insulating layer IIL1. That is, the gate insulating layer IIL1 may be disposed between the semiconductor layer Act and the gate electrode GE to provide insulation between the semiconductor layer Act and the gate electrode GE. The gate electrode GE may overlap the channel region of the semiconductor layer Act. The gate electrode GE may include a low resistance metal material. According to an embodiment, the gate electrode GE may include a conductive material including molybdenum (Mo), aluminum (Al), copper (Cu), and titanium (Ti), and may have a single-layer or multi-layer structure including the aforementioned conductive materials.

The first interlayer insulating layer IIL2 may be disposed on the gate electrode GE and the gate insulating layer IIL1. The first interlayer insulating layer IIL2 may include an inorganic insulating material such as silicon oxide (SiO_{X}), silicon nitride (SiN_{X}), or silicon oxynitride (SiO_{X}N_{Y}). For example, the first interlayer insulating layer IIL2 may have a single-layer or multi-layer structure including the above-mentioned material.

The source electrode SE and the drain electrode DE may be arranged on the first interlayer insulating layer IIL2. The source electrode S and the drain electrode D may each be connected to the semiconductor layer Act via contact holes formed in the gate insulating layer IIL1 and the first interlayer insulating layer IIL2. At least one of the source electrode SE and the drain electrode DE may include a conductive material including, for example, molybdenum (Mo), aluminum (Al), copper (Cu), or titanium (Ti), and may have a multi-layer or single-layer structure including the aforementioned conductive materials. According to an embodiment, at least one of the source electrode SE and the drain electrode DE may have a multi-layer structure of Ti/Al/Ti.

Embodiments are not limited thereto. For example, the transistor TFT may include only one of the source electrode SE and the drain electrode DE, or may include neither of them. For example, one transistor TFT may not include the drain electrode DE, another transistor TFT connected to the one transistor TFT may not include the source electrode SE, and the semiconductor layers Act of these two transistors may be connected to each other. This connection structure may provide the same effect as when one transistor TFT includes the source electrode SE and another transistor TFT includes the drain electrode DE and the source electrode SE of the one transistor TFT is connected to the drain electrode DE of the other transistor TFT.

The second interlayer insulating layer IIL3 may be disposed on the source electrode SE, the drain electrode DE, and the first interlayer insulating layer IIL2. The second interlayer insulating layer IIL3 may include an inorganic insulating material such as silicon oxide (SiO_{X}), silicon nitride (SiN_{X}), or silicon oxynitride (SiO_{X}N_{Y}). For example, the second interlayer insulating layer IIL3 may have a single-layer or multi-layer structure including the above-mentioned material.

The organic insulating layer OIL may be arranged on the second interlayer insulating layer IIL3. The organic insulating layer OIL may substantially planarize the top of the pixel circuit layer 200. The organic insulating layer OIL may include an organic material, such as, acryl, benzocyclobutene (BCB) or hexamethyldisiloxane (HMDSO). Although the organic insulating layer OIL is a single layer in FIG. 20, various modifications may be made to the organic insulating layer OIL. For example, the organic insulating layer OIL may be a stack of multiple layers.

The display element layer 300 may be disposed on the pixel circuit layer 200. The display element layer 300 may include a display element 310 and a pixel defining layer 320. The display element 310 may be electrically connected to the transistor TFT. The display element 310 may be, for example, an organic light-emitting diode having a pixel electrode 311, an opposite electrode 313, and an emission layer 312 interposed therebetween. The display element 310 being electrically connected to the transistor TFT may be understood as the pixel electrode 311 of the organic light-emitting diode being electrically connected to the transistor TFT.

The pixel electrode 311 may contact one of the source electrode SE and the drain electrode DE through a contact hole formed in the second interlayer insulating layer IIL3 and the organic insulating layer OIL, and may be electrically connected to the transistor TFT. The pixel electrode 311 may include a conductive oxide such as indium tin oxide (ITO), indium zinc oxide (IZO), zinc oxide (ZnO), indium oxide (In₂O₃), indium gallium oxide (IGO), or aluminum zinc oxide (AZO). According to another embodiment, the pixel electrode 311 may include a reflective layer including, for example, silver (Ag), magnesium (Mg), aluminum (Al), platinum (Pt), palladium (Pd), gold (Au), nickel (Ni), neodymium (Nd), iridium (Ir), chromium (Cr), or a compound of these materials. According to another embodiment, the pixel electrode 311 may further include a film formed of ITO, IZO, ZnO, or In₂O₃ over/under the reflection layer.

A pixel defining layer 320 may cover an edge of the pixel electrode 311. The pixel defining layer 320 may include a pixel opening, and the pixel opening may overlap the pixel electrode 311. For example, the pixel opening may expose a central portion of the pixel electrode 311 of the display element 310, and at least a portion of the emission layer 312 of the display element 310 may be located within the pixel opening. An emission area of light emitted by the display element 310 may be defined by the pixel opening.

In such a case as illustrated in FIG. 20, the pixel defining layer 320 may increase a distance between an edge of the pixel electrode 311 and the opposite electrode 313 over the pixel electrode 311. Accordingly, an arc or the like may be prevented from occurring on the edge of the pixel electrode 311. The pixel defining layer 320 may include an organic insulating material, for example, polyimide or HMDSO. According to some embodiments, the pixel defining layer 320 may include a light blocking material.

The opposite electrode 313 may be disposed on the pixel electrode 311. The opposite electrode 313 may be provided integrally over an entire surface of the substrate 100, and thus may be provided commonly in a plurality of display elements 310. In this regard, the opposite electrode 313 may be integrally provided over the plurality of display elements 310. Accordingly, the opposite electrode 313 may correspond to a plurality of pixel electrodes 311. The opposite electrode 313 may include a light-transmissive conductive layer formed of ITO, In₂O₃, or IZO, and also include a semi-transmissive layer including a metal such as Al or Ag. For example, the opposite electrode 313 may be a semi-transmissive layer including Mg or Ag.

The emission layer 312 capable of emitting light may be interposed between the pixel electrode 311 and the opposite electrode 313. The emission layer 312 may emit red light, green light, or blue light. The emission layer 312 may include a high molecular or low molecular weight organic material capable of emitting light of a certain color (e.g., red, green, or blue). For example, the emission layer 312 may include a high-molecular weight material such as a polyphenylene vinylene (PPV)-based material or a polyfluorene-based material. The emission layer 312 may be formed via screen printing, inkjet printing, laser induced thermal imaging (LITI), or the like. However, embodiments are not limited thereto.

According to an embodiment, function layers may be disposed below and over the emission layer 312. The functional layers may include an hole injection layer (HIL), a hole transport layer (HTL), an electron transport layer (ETL), and/or an electron injection layer (EIL). Each of the functional layers may be integrated over the plurality of pixel electrodes 311, or may be patterned to correspond to the plurality of pixel electrodes 311.

Because the display element 310 may be easily damaged by external moisture, oxygen, or the like, the encapsulation layer 400 may cover and protect the display element 310. As illustrated in FIG. 20, the encapsulation layer 400 may include a first inorganic encapsulation layer 410, an organic encapsulation layer 420, and a second inorganic encapsulation layer 430.

The first inorganic encapsulation layer 410 may cover the opposite electrode 313 and may include silicon oxide (SiO_{X}), silicon nitride (SiN_{X}) and/or silicon oxynitride (SiO_{X}N_{Y}). As necessary, other layers, such as, a capping layer, may be interposed between the first inorganic encapsulation layer 410 and the opposite electrode 313. Because the first inorganic encapsulation layer 410 is formed along structures below the first inorganic encapsulation layer 410, the upper surface thereof may not be flat, as shown in FIG. 20. The organic encapsulation layer 420 covers the first inorganic encapsulation layer 410. In contrast with the first inorganic encapsulation layer 410, the organic encapsulation layer 420 may have an approximately flat upper surface. The organic encapsulation layer 420 may include at least one material from among polyethylene terephthalate, polyethylene naphthalate, polycarbonate, polyimide, polyethylene sulfonate, polyoxymethylene, polyarylate, and hexamethyldisiloxane. The second inorganic encapsulation layer 430 may cover the organic encapsulation layer 420, and may include silicon oxide (SiO_{X}), silicon nitride (SiN_{X}) and/or silicon oxynitride (SiO_{X}N_{Y}).

As such, the encapsulation layer 400 includes the first inorganic encapsulation layer 410, the organic encapsulation layer 420, and the second inorganic encapsulation layer 430, and thus, even when the encapsulation layer 400 cracks due to this multi-layered structure, this crack may not be connected between the first inorganic encapsulation layer 410 and the organic encapsulation layer 420 or between the organic encapsulation layer 420 and the second inorganic encapsulation layer 430. Accordingly, formation of a path via which external moisture, oxygen, or the like permeates into the display panel DP may be prevented or minimized.

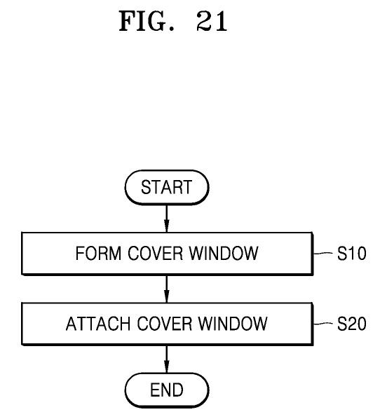

FIG. 21 is a flowchart of a portion of a method of manufacturing an electronic apparatus, according to an embodiment. In detail, FIG. 21 is a flowchart of a method of manufacturing the display apparatus 10 included in the electronic apparatus 1.

Referring to FIG. 21, the method of manufacturing the electronic apparatus, according to an embodiment, may include a cover window forming operation S10 and a cover window attaching operation S20.

First, the cover window CW may be formed in the cover window forming operation S10. The cover window CW may correspond to the etched glass substrate GS in embodiments described above with reference to FIGS. 1 - 8, 11, 12, and 13. A method of etching the glass substrate GS has been described above with reference to FIGS. 1 - 8, 11, 12, and 13, and thus a detailed description thereof will be omitted. That is, the cover window forming operation S10 may include a first organic layer forming operation S100, a second organic layer forming operation S200, a first organic layer removing operation S300, a glass substrate etching operation S400, and a second organic layer removing operation S500.

In detail, the first organic layer OL1 having a shape corresponding to the groove G may be formed on the first glass portion GS1 of the glass substrate GS, and the second organic layer OL2 may be formed on the second glass portion GS2 of the glass substrate GS that is in contact with (i.e., adjacent) the first glass portion GS1. The formed second organic layer OL2 may cover at least a portion of the first organic layer OL1. Next, after the first organic layer OL1 is removed, the glass substrate GS may be etched. Then, the second organic layer OL2 may be removed to form the cover window CW.

Thereafter, the cover window CW may be attached to the display panel DP in the cover window attaching operation S20. The description of the display panel DP given above with reference to FIGS. 18 - 20 is also applied to the display panel DP to which the cover window CW is attached, so a detailed description thereof is omitted.

In detail, an adhesive layer may be attached to a lower surface of the cover window CW, and the cover window CW with the adhesive layer attached thereto may be attached to an upper surface of the display panel DP. Alternatively, an adhesive layer may be attached to the upper surface of the display panel DP, and the cover window CW may be attached to the upper surface of the display panel DP with the adhesive layer attached thereto. Because attaching the cover window CW to the display panel DP by using an adhesive layer is obvious to those skilled in the art, a detailed description thereof is omitted.

According to an embodiment as described above, a glass processing apparatus capable of easily etching glass into a preset shape, a glass processing method performed by the glass processing apparatus, and a method of manufacturing an electronic apparatus may be implemented. Of course, the scope of embodiments are not limited to these effects.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope as defined by the following claims.

What is claimed is:

1. A glass processing method comprising:
providing a glass substrate comprising a first glass portion and a second glass portion that is adjacent the first glass portion;
forming a first organic layer on the first glass portion;
forming a second organic layer on the second glass portion and a portion of the first organic layer;
removing the first organic layer;
etching the glass substrate; and
removing the second organic layer.

2. The glass processing method of claim 1, wherein the etching of the glass substrate comprises etching the first glass portion and a portion of the second glass portion adjacent to the first glass portion.

3. The glass processing method of claim 1, wherein the forming of the first organic layer comprises discharging a first solution onto the first glass portion and irradiating the first solution with ultraviolet light,
wherein the forming of the second organic layer comprises discharging a second solution onto the second glass portion and the portion of the first glass portion and irradiating the second solution with ultraviolet light,
wherein the removing of the first organic layer comprises removing the first organic layer by using a first solvent containing water and not removing the second organic layer,
wherein the removing of the second organic layer comprises removing the second organic layer by using a second solvent, which is an organic solvent, and
wherein at least one of the removing of the first organic layer and the removing of the second organic layer comprises at least one of heating and ultrasonic vibration.

4. The glass processing method of claim 3, wherein the first solution comprises at least one of polyvinylalcohol, polyvinylpyrrolidone, polyacrylic acid, polyethylene glycol, polyglycidol, hydroxyethyl cellulose, methyl cellulose, carboxymethyl cellulose, and dextrin, and
wherein the second solution comprises at least one of polystyrene, polymethyl methacrylate, novolac resin, polyimide, epoxy resin, acrylic resin, polyvinylphenol, polyhydroxystyrene, cycloolefin polymer, and polycarbonate.

5. The glass processing method of claim 3, wherein the first solution comprises at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

6. The glass processing method of claim 3, wherein the second solution comprises at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

7. The glass processing method of claim 3, wherein the forming of the second organic layer comprises radiating a first amount of ultraviolet light radiated to the second solution on the portion of the first glass portion is different from a second amount of ultraviolet light radiated to the second solution on the second glass portion.

8. The glass processing method of claim 7, wherein the first amount of ultraviolet light is greater than the second amount of ultraviolet light.

9. The glass processing method of claim 1, wherein the forming of the second organic layer comprises forming a second-1 organic portion of the second organic layer on the portion of the first glass portion and forming a second-2 organic portion of the second organic layer on the second glass portion to directly contact the second glass portion.

10. The glass processing method of claim 9, wherein the second-1 organic portion is thicker than the second-2 organic portion.

11. A glass processing apparatus comprising:
a discharge device configured to discharge a first solution and a second solution onto a glass substrate;
an irradiation device configured to radiate ultraviolet light to the first solution and the second solution on the glass substrate;
a removal device configured to remove a first organic layer formed from the first solution and a second organic layer formed from the second solution and etch the glass substrate; and
a controller configured to:
control the discharge device and the irradiation device to form the first organic layer on a first glass portion of the glass substrate,
control the discharge device and the irradiation device to form the second organic layer on a second glass portion of the glass substrate adjacent the first glass portion, and on a portion of the first organic layer,
control the removal device to remove the first organic layer,
control the removal device to etch the glass substrate, and
control the removal device to remove the second organic layer.

12. The glass processing apparatus of claim 11, wherein the controller is further configured to control the removal device to etch the first glass portion and a portion of the second glass portion adjacent to the first glass portion.

13. The glass processing apparatus of claim 11, wherein the controller is further configured to:
control the discharge device to discharge the first solution onto the first glass portion and control the irradiation device to radiate ultraviolet light to cure the first solution and form the first organic layer,
control the discharge device to discharge the second solution onto the second glass portion and the portion of the first glass portion, and control the irradiation device to radiate ultraviolet light to cure the second solution and form the second organic layer,
control the removal device to remove the first organic layer by using a first solvent containing water and to not remove the second organic layer, and
control the removal device to remove the second organic layer by using a second solvent, which is an organic solvent, and
wherein the removal device is configured to apply at least one of heating and ultrasonic vibration when removing the first organic layer or the second organic layer.

14. The glass processing apparatus of claim 13, wherein the first solution comprises at least one of polyvinylalcohol, polyvinylpyrrolidone, polyacrylic acid, polyethylene glycol, polyglycidol, hydroxyethyl cellulose, methyl cellulose, carboxymethyl cellulose, and dextrin, and
wherein the second solution comprises at least one of polystyrene, polymethyl methacrylate, novolac resin, polyimide, epoxy resin, acrylic resin, polyvinylphenol, polyhydroxystyrene, cycloolefin polymer, and polycarbonate.

15. The glass processing apparatus of claim 13, wherein the first solution comprises at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

16. The glass processing apparatus of claim 13, wherein the second solution comprises at least one of carbon black, titanium dioxide (TiO₂), zinc oxide (ZnO), iron oxide (Fe₂O₃), a benzophenone-based compound, a benzotriazole-based compound, a triazine-based compound, and an anthraquinone-based compound.

17. The glass processing apparatus of claim 13, wherein the controller is further configured to control the irradiation device so that a first amount of ultraviolet light radiated to the second solution on the portion of the first glass portion is greater than a second amount of ultraviolet light radiated to the second solution on the second glass portion.

18. The glass processing apparatus of claim 11, wherein the controller is further configured to control the discharge device and the irradiation device so that a second-1 organic portion of the second organic layer formed on the first glass portion overlaps a portion of the first organic layer and a second-2 organic portion of the second organic layer formed on the second glass portion comes into direct contact with the second glass portion.

19. The glass processing apparatus of claim 18, wherein the controller is further configured to control the discharge device and the irradiation device so that the second-1 organic portion is thicker than the second-2 organic portion.

20. A method of manufacturing an electronic apparatus, the method comprising:
forming a cover window; and
attaching the cover window to a display panel,
wherein the forming of the cover window comprises:
providing a glass substrate comprising a first glass portion and a second glass portion that is adjacent the first glass portion;
forming a first organic layer on the first glass portion;
forming a second organic layer on the second glass portion and a portion of the first organic layer;
removing the first organic layer;
etching the glass substrate; and
removing the second organic layer.
